(19) United States
(12) Patent Application Publication
(10) Pub. No.: US 2008/0297649 A1
(43) Pub. Date: Dec. 4, 2008

(54) METHODS AND APPARATUS PROVIDING LIGHT ASSISTED AUTOMATIC FOCUS

(76) Inventor: Igor Subbotin, South Pasadena, CA (US)

Correspondence Address: DICKSTEIN SHAPIRO LLP, 1825 EYE STREET NW, Washington, DC, 20006-5403, US

(21) Appl. No.: 11/756,282

(22) Filed: May 31, 2007

(51) Int. Cl. G03B 13/00

(52) U.S. Cl. 348/352; 348/E05.024

(57) ABSTRACT

Methods and apparatus for accurately auto focusing a lens of an imaging device. The method includes the steps of focusing an image of a subject on an imager, determining that the subject has moved, and refocusing the image of the subject on the imager by comparing a first brightness of a first scene captured before determining that the subject has moved and a second brightness of a second scene captured after determining that the subject has moved. The first brightness and second brightness are provided with the assistance of a light source.

### FIELD OF THE INVENTION

Embodiments of the invention relate generally to an imaging device for capturing photo images and more particularly to an auto focusing technique for an imaging device.

### BACKGROUND OF THE INVENTION

Most cameras, including digital cameras, have an automatic focus feature (referred to herein as “auto focus”) in which subjects viewed through the camera can be focused on automatically. Auto focus systems are generally categorized as either active or passive systems. Active systems actually determine the distance between the camera and the subject of the scene by measuring the total travel time of ultrasonic waves or infrared light emitted from the camera. Based on the total travel time, the distance between the camera and the subject of the scene may be calculated and the appropriate lens position may be selected. Passive auto focus systems, on the other hand, do not require the emission of ultrasonic waves or infrared light, but instead simply rely on the light that is naturally reflected by the subject in the scene.

One example of a passive auto focus system is a system that uses contrast analysis to determine the best focal position for the camera lens. In a contrast analysis auto focus system, adjacent areas of a scene are compared with each other to measure differences in intensity among the adjacent areas. An out-of-focus scene will include adjacent areas that have similar intensities, while a focused scene will likely show a significant contrast between areas in which the subject of the scene is located and other areas of the scene (e.g., background objects). As the camera incrementally moves the lens during the auto focus operation, each area of the scene is analyzed to determine differences in intensity between adjacent areas. When a particular lens position results in the maximum intensity difference between adjacent areas, the camera will use that lens position for its auto focus lens setting.

Conventional auto focus systems have difficulty with continuously auto focusing on a moving subject, especially when all focusing decisions must be made using only statistical information from the image frames. A standard approach for continuous auto focusing is to refocus on the subject each time motion in the scene is detected. In general, conventional auto focus systems perform a process of 1) focusing on a subject, 2) detecting motion in the scene, and 3) refocusing on the subject. In a passive system, it may take several steps to refocus on the subject because the system makes incremental focusing adjustments until the optimal focus position is obtained.

Accordingly, there is a need and a desire for an improved method of auto focusing an imaging device to capture a moving subject.

### BRIEF DESCRIPTION OF THE DRAWINGS

FIG. 1 is a flowchart of a method according to a disclosed embodiment.

FIG. 2 is a block diagram of an imaging device for use with methods according to various disclosed embodiments.

FIG. 3 is a flowchart of a method according to a disclosed embodiment.

FIG. 4 is a block diagram of an imager for use in an imaging device for use with methods according to various disclosed embodiments.

### DETAILED DESCRIPTION OF THE INVENTION

In the following detailed description, reference is made to various embodiments that are described with sufficient detail to enable those skilled in the art to practice them. It is to be understood that other embodiments may be employed, and that various structural, logical and electrical changes may be made.

Various embodiments described herein relate to a method and system for auto focusing an imaging device on a moving subject. In one embodiment, the distance of the moving subject from the imaging device is determined by measuring a change in brightness of light reflected from the subject at a first location and light reflected from the subject at a second location. The imaging device is then focused using the determined distance of the subject from the imaging device.

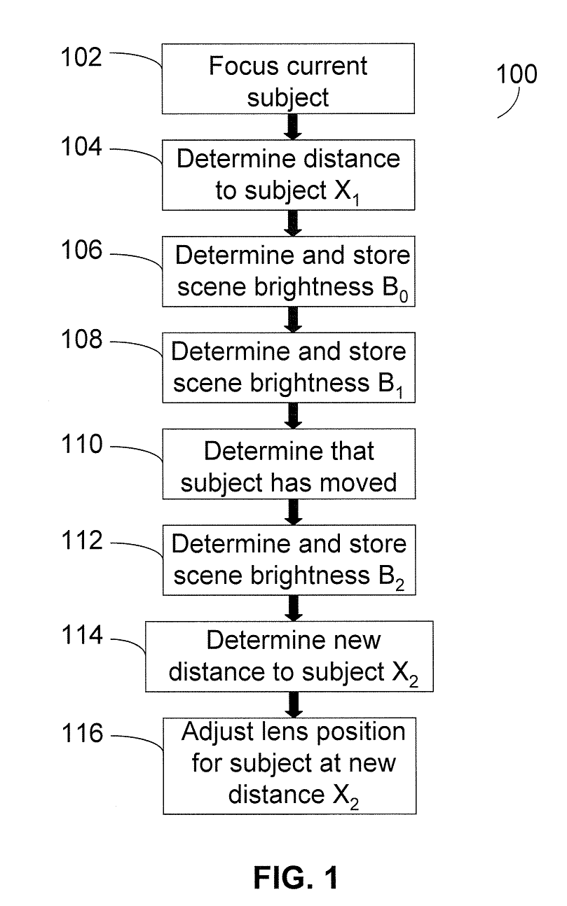

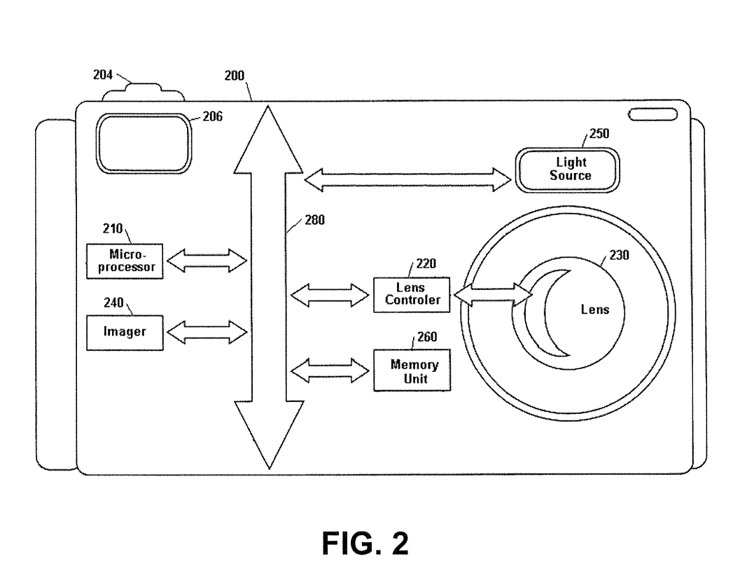

FIG. 1 illustrates a method 100 preformed by a controller associated with an imaging device according to an embodiment. FIG. 2 illustrates internal circuitry and physical components of an imaging device 200, such as a digital camera, for use with the method described in FIG. 1. The imaging device 200, shown as a digital camera, includes a microprocessor 210 or other circuit acting as a controller, a lens controller 220, a lens 230, an imager 240, a memory unit 260, and a light source 250, such as a flash. The elements of the imaging device 200 communicate over one or more busses 280. In one embodiment, the light source 250 may be attached to or part of the imaging device 200. In another embodiment, the light source 250 may be located remotely from the imaging device 200. The microprocessor 210 or other control circuit may also be integrated with the imaging device 200. A shutter release button 204 and a view finder 206 are also included in the illustrated imaging device 200. When the shutter release button 204 is depressed, an image can be input through the lens 230 and impinge upon the imager 240, which has an array of pixels for capturing an image.

Turning to FIG. 1, at step 102, the imaging device 200 focuses on a subject in a scene. In one embodiment, the microprocessor 210 controls the lens 230 (via lens controller 220) to focus the image of the subject on the imager 240 using a passive focusing technique, such as, e.g., using contrast analysis to determine the best focal position. The microprocessor 210 instructs the lens controller 220 to adjust the lens 230 position until the image of the subject is properly focused on the imager 240. In one embodiment, the imaging device 200 may implement the focusing technique disclosed in U.S. application Ser. No. 11/354,126, filed Feb. 15, 2006, the disclosure of which is incorporated herein by reference in its entirety.

At step 104, the method 100 determines the distance between the subject and the imaging device 200. This distance is referred to herein as the first distance X₁. The microprocessor 210 determines the first distance X₁ using the current focused lens position and by correlating the first distance X₁ to the position of the lens 230 as determined in step 102. In one embodiment, the memory unit 260 includes a look-up table correlating known positions of the lens 230 to known distances between an in-focus subject and the imaging device 200. The first distance X₁ is then stored in the memory unit 260.

At step 106, the method 100 determines the background brightness B₀ of the scene including the subject at the first distance X₁. To do so, an image of the scene under ambient light is captured by the imager 240, which outputs the image to the microprocessor 210. In one embodiment, the microprocessor 210 determines the background brightness B₀ by calculating the total brightness of the scene from the image. In one embodiment, the total brightness of the scene is calculated by adding up all of the pixel brightness values and dividing by the number of pixels. The microprocessor 210 stores the background brightness B₀ in the memory unit 260.

At step 108, the method 100 determines the brightness of the scene including the subject at the first distance X₁ and as illuminated by light from the light source 250. To do so, the microprocessor 210 instructs the light source 250 to emit light thus illuminating the subject. In one embodiment, the light source 250 may be a flash, and may flash each time the subject is to be illuminated. In another embodiment, the light source 250 may be a continuous light source, such as a spotlight, and may emit light throughout the method 100, with the exception of step 106.

The image of the scene including the illuminated subject at the first distance X₁ is captured by the imager 240, which sends the image to the microprocessor 210. The microprocessor 210 determines the brightness B₁ of the scene by calculating the total brightness of the scene from the captured image. The microprocessor 210 stores the calculated brightness B₁ in the memory unit 260.

At step 110, the method 100 determines that the subject has moved. In one embodiment, the microprocessor 210 detects that the subject has moved using a technique similar to a passive focusing technique. That is, when the microprocessor 210 detects that the image of the subject from the imager 240 is no longer in focus, such as by performing contrast analysis as described above, the microprocessor 210 determines that the subject has moved. When the microprocessor 210 determines that the subject has moved, the method proceeds to step 112. In another embodiment, step 110 may be omitted and the method may proceed to step 112 after a timed interval. In another embodiment, if the subject does not move in a set time period, the method 100 may continue at step 102 or the method 100 may end.

At step 112, because the subject has moved, the method 100 determines the brightness of the scene including the subject at a second distance X₂ and as illuminated by the light source 250. The second distance X₂ is the distance from the imaging device 200 to the location to which the subject has moved. After the microprocessor 210 has determined that the subject has moved, the microprocessor 210 instructs the light source 250 to emit light, thus illuminating the subject. The image of the scene including the illuminated subject at the second distance X₂ is captured by the imager 240, which sends the image to the microprocessor 210. The microprocessor 210 determines the brightness B2 of the scene by calculating the total brightness of the scene from the newly captured image. The microprocessor 210 stores the brightness B₂ in the memory unit 260.

At step 114, the imaging device determines the second distance X₂ as described below. The brightness of the light reflected from a subject decreases in proportion to the square of the distance to the light source 250. Equation 1 shows a formula for comparing the distance of the subject to the brightness of the subject for the first distance X₁ and the second distance X₂.

$$\begin{matrix}Equation 1 \text{:} & \\ {( \frac{{X}_{1}}{{X}_{2}} )}^{2} = \frac{( {B}_{1} - {B}_{0} )}{( {B}_{2} - {B}_{0} )} & \end{matrix}$$

The microprocessor 210 calculates the second distance X₂ using equation 2.

$$\begin{matrix}Equation 2 \text{:} & \\ {X}_{2} = {X}_{1} / \sqrt{\frac{( {B}_{1} - {B}_{0} )}{( {B}_{2} - {B}_{0} )}} & \end{matrix}$$

If the light source 250 is located away from the imaging device 200, Equation 2 may be modified to account for the distance from the light source 250 to the imaging device 200.

At step 116, the method 100 focuses on the subject at its new location. To do so, the microprocessor 210 instructs the lens controller 220 to adjust the lens 230 to a position that will properly focus an image of the subject located at the second distance X₂ on the imager 240. In one embodiment, the memory unit 260 includes a look-up table correlating known distances of a subject to the imaging device 200 to known positions of the lens 230.

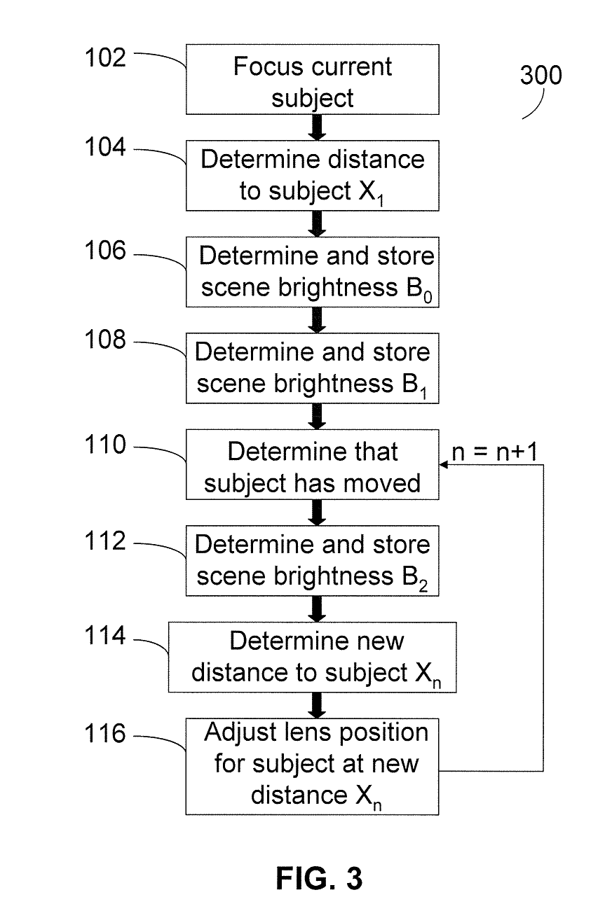

The method 100 may be continuously repeated to keep the subject in focus over a period of time. In one embodiment, the method 100 may start over from step 102 and progress through step 116, to determine new values of B₀, B₁, B₂, X₁, and X₂. In another embodiment, shown in FIG. 3, the method 300 may repeat steps 110 to 116 using the original values of B₀, B₁, and X₁, to determine new values for Bₙ₊₁ and Xₙ₊₁ as the subject moves, where n is the number of the times the distance Xₙ of the subject from the imaging device 200 is calculated. In this way, a continuous auto focus operation may be practiced to provide maximum sharpness for a moving subject.

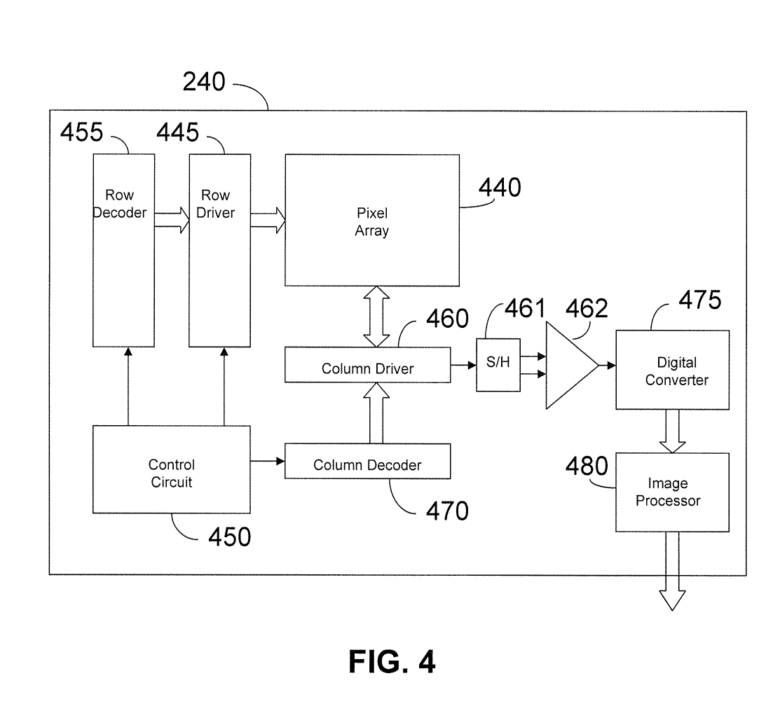

An imager 240, for example, a CMOS imager, for use with the imaging device 200 is shown in FIG. 4. The imager 240 has a pixel array 440 comprising a plurality of pixels arranged in a predetermined number of columns and rows. Attached to the array 440 is signal processing circuitry. The pixels of each row in array 440 are all turned on at the same time by a row select line, and the pixels of each activated row are selectively output by respective column select lines. A plurality of row and column select lines are provided for the entire array 440. The row lines are selectively activated by a row driver 445 in response to row address decoder 455. The column select lines are selectively activated by a column driver 460 in response to column address decoder 470. Thus, a row and column address is provided for each pixel.

The imager 240 is operated by the timing and control circuit 450, which controls address decoders 455, 470 for selecting the appropriate row and column lines for pixel readout. The control circuit 450 also controls the row and column driver circuitry 445, 460 such that they apply driving voltages to the drive transistors of the selected row and column select lines. The pixel column signals, which for a CMOS imager typically include a pixel reset signal (Vᵣₛₜ) and a pixel image signal (V_{sig}), are read by a sample and hold circuit 461. Vᵣₛₜ is read from a pixel immediately after a charge storage region is reset. V_{sig} represents the amount of charges generated by the pixel's photosensitive element and stored in the charge storage region in response to applied light to the pixel. A differential signal of Vᵣₛₜ and V_{sig} is produced by differential amplifier 462 for each pixel. The differential signal is digitized by analog-to-digital converter 475 (ADC). The analog-to-digital converter 475 supplies the digitized pixel signals to an image processor 480, which forms and outputs a digital image. In one embodiment, the image processor 480 may perform some or all of the functions of the microprocessor 210 in the method described above with reference to FIGS. 1 and 3. The imager 240 may also include a separate memory unit (not shown), which may perform some or all of the functions of the memory unit 260.

The processes and devices described above illustrate example methods and devices of many that could be used to implement the various embodiments. For example, the various embodiments described herein could be used with a still or video camera. It is not intended that the present be strictly limited to the above-described and illustrated embodiments and is only limited by the scope of the appended claims.

What is claimed as new and desired to be protected by Letters Patent of the United States is:

1. A method of automatically focusing an imaging device comprising:
focusing an image of a subject on a pixel array;
determining that the subject has moved; and
refocusing the image of the subject on the pixel array using a first brightness of a first scene captured before determining that the subject has moved and a second brightness of a second scene captured after determining that the subject has moved.

2. The method of claim 1, further comprising focusing the image of the subject on the pixel array using scene contrast analysis.

3. The method of claim 1, further comprising determining that the subject has moved using scene contrast analysis.

4. The method of claim 1, wherein the first brightness and the second brightness are used to determine a distance of the subject to the pixel array after the subject has moved.

5. The method of claim 1, wherein refocusing the image of the subject on the pixel array comprises correlating the distance of the subject to the pixel array to a position of a lens at which the subject is in focus.

6. The method of claim 1, wherein refocusing the image of the subject on the pixel array further comprises:
determining a first distance of the subject from the imaging device;
determining a background brightness of the first scene including the subject at the first distance;
illuminating the subject a first time;
determining the first brightness of the first scene including the illuminated subject at the first distance;
illuminating the subject a second time after determining that the subject has moved;
determining the second brightness of the second scene including the illuminated subject at a second distance; and
determining the second distance.

7. The method of claim 6, wherein a lens position is adjusted to focus the image of the subject on the pixel array, and wherein the first distance is determined by correlating the position of the lens to the first distance.

8. The method of claim 7, wherein the position of the lens is correlated to the first distance using a look-up table.

9. The method of claim 6, wherein a position of a lens is adjusted to refocus the image of the subject on the pixel array by correlating the second distance to the lens position.

10. The method of claim 9, wherein the second distance is correlated to the position of the lens using a look-up table.

11. The method of claim 6, wherein the background brightness is determined under ambient light conditions.

12. The method of claim 6, wherein the background brightness, the first brightness, and the second brightness are determined by obtaining images with the pixel array and analyzing the images to determine the total brightness.

13. The method of claim 6, wherein the subject is illuminated by a source for adding light to the subject.

14. The method of claim 13, wherein the subject is illuminated by a flash device.

15. The method of claim 6, wherein the second distance is calculated using the equation:
$${X}_{2} = {X}_{1} / \sqrt{\frac{( {B}_{1} - {B}_{0} )}{( {B}_{2} - {B}_{0} )}}$$
where X₂ is the second distance, X₁ is the first distance, B₀ is the background brightness, B₁ is the first brightness, and B₂ is the second brightness.

16. The method of claim 6, further comprising:
illuminating the subject a third time after determining the subject has moved;
determining a third brightness of a third scene including the illuminated subject at a third distance;
calculating the third distance; and
refocusing the imaging device on the subject at the third distance.

17. A method of automatically focusing an imaging device comprising:
focusing an image of a subject on an imager by adjusting a lens position;
determining a first distance of the subject to the imaging device by correlating the lens position to the first distance;
determining a first brightness of a captured first scene including the subject under ambient light at the first distance;
illuminating the subject with a flash;
determining a second brightness of a captured second scene including the illuminated subject at the first distance;
determining that the subject has moved to a second distance from the imaging device;
illuminating the subject with a flash;
determining a third brightness of a captured third scene including the illuminated subject at the second distance;
calculating the second distance; and
adjusting the lens position to focus the image of the subject at the second distance on the imager.

18. The method of claim 17, wherein focusing the image of the subject on the imager by adjusting the lens position comprises using contrast measurements to determine the lens position.

19. The method of claim 17, wherein the first brightness, the second brightness, and the third brightness are determined by obtaining images with the imager and analyzing the images to determine the total brightness.

20. The method of claim 17, wherein determining that the subject has moved comprises using contrast measurements.

21. The method of claim 17, wherein the second distance is calculated using the equation:
$${X}_{2} = {X}_{1} / \sqrt{\frac{( {B}_{1} - {B}_{0} )}{( {B}_{2} - {B}_{0} )}}$$
where X₂ is the second distance, X₁ is the first distance, B₀ is the first brightness, B₁ is the second brightness, and B₂ is the third brightness.

22. An imaging device for performing an automatic focus function, said imaging device comprising:
a lens;
an imager for capturing an image of a subject focused through the lens;
a light source for illuminating the subject; and
a circuit configured to adjust the lens position to focus the image of the subject on the imager, and to refocus the image of the subject on the imager using a first brightness of a first scene captured before making a determination that the subject has moved and a second brightness of a second scene captured after making a determination that the subject has moved.

23. The imaging device of claim 22, wherein, to refocus the image of the subject on the imager, the circuit is further configured to:
determine a first distance of the subject from the imaging device;
determine a background brightness of the first scene including the subject at the first distance;
cause the light source to illuminate the subject a first time;
determine the first brightness of the first scene including the illuminated subject at the first distance;
cause the light source to illuminate the subject a second time after determining that the subject has moved;
determine the second brightness of the second scene including the illuminated subject at a second distance; and
determine the second distance.

24. The imaging device of claim 22, wherein said circuit is a microprocessor.

25. The imaging device of claim 22, further comprising a memory unit comprising a look-up table comprising information to correlate a distance of a subject from the imaging device to a position of the lens required to focus an image of the subject on the imager.

26. The imaging device of claim 22, wherein the light source is a flash.

27. The imaging device of claim 22, wherein the imaging device is a digital camera.

28. The imaging device of claim 22, wherein the imaging device is a video camera.
